(19) United States
(12) Patent Application Publication
(10) Pub. No.: US 2004/0182010 A1
(43) Pub. Date: Sep. 23, 2004

(54) Seal element for a movable vehicle component

(76) Inventors: Wilfried Kalb, Leonberg (DE); Dieter Raisch, Rutesheim (DE)

Correspondence Address: KLAUS J. BACH & ASSOCIATES, 4407 TWIN OAKS DRIVE, MURRYSVILLE, PA, 15668, US

(21) Appl. No.: 10/393,827

(22) Filed: Mar. 21, 2003

(51) Int. Cl. E06B 7/16

(52) U.S. Cl. 49/441

(57) ABSTRACT

In a seal element for a movable vehicle component including a support structure comprising at least two sections, the at least the two sections are joined by a hinge portion to permit manufacturing of the seal element with the sections disposed flat in a plane, but permitting pivotal bending of the sections relative to each other upon installation of the seal element in a vehicle component.

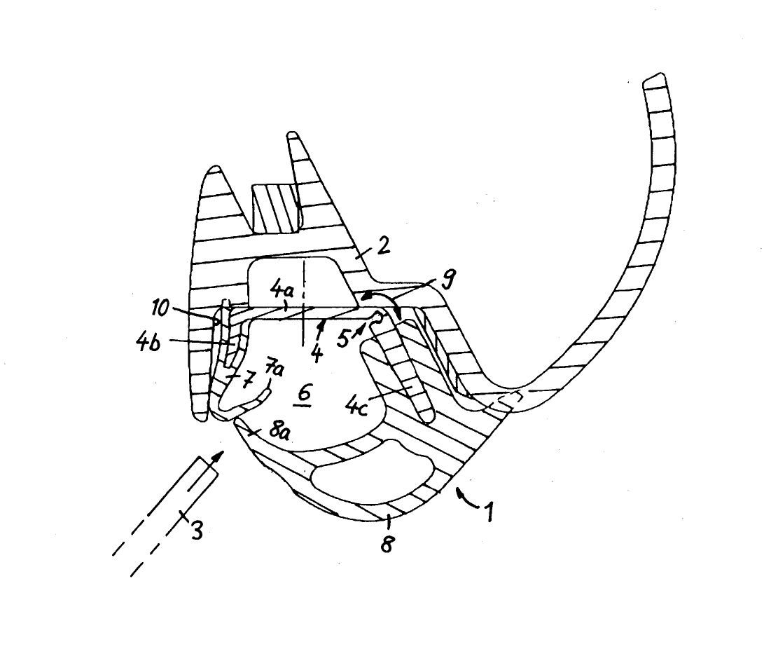

### BACKGROUND OF THE INVENTION

The invention resides in a seal element for a movable vehicle component comprising a support structure and a seal member at opposite sides of the support structure.

DE 198 01 870 A1 discloses a seal element which is installed in the window frame of a movable motor vehicle side window and which is to provide a watertight seal for the window panel when the window is closed. The seal element consists of a two-part support track comprising two individual track elements, which, in the area of an overlapping section are riveted together to a vehicle component. Onto the free ends of the track element, seal structures are molded, which include inwardly projecting seal lips, which delimit a reception space for the upper edge of the window panel. The bottom of the reception space is formed by the U-shaped track elements of the support track.

The two track elements of the support track can be moved relative to each other before they are fixed to the vehicle. They must be fixed over the rivet so that, during mounting, an additional degree of freedom must be taken into consideration which is to be adjusted in accordance with the design limits. On one hand, this improves the possibilities for use of the seal element, but, on the other hand, both individual elements must be assembled to form a common seal element, which increases manufacturing expenses for the seal element as well as assembly expenses.

DE 295 09 880 U1 discloses a seal element with an approximately U-shaped support structure which forms a reception opening and which has opposite sides each provided with a seal member. The two seal members have seal lips which are disposed in contact with each other and which delimit the reception space. A vehicle window panel is movable into the reception space whereupon the two sealing lips sealingly engage the window pane from opposite sides.

However, the installation conditions of the seal element in the vehicle body or the vehicle roof are limited by the shape of the support structure. Different installation conditions require differently formed seal elements. The manufacturing and vehicle installation expenses are therefore relatively high.

It is the object of the present invention to provide a seal element which is reinforced by a support structure and which, when installed, provides a reception space for a component to be sealed and which also requires relatively low manufacturing and installation expenses.

### SUMMARY OF THE INVENTION

In a seal element for a movable vehicle component including a support structure comprising at least two sections, at least the two sections are joined by a hinge portion to permit manufacturing of the seal element with the sections disposed flat in a plane, but permitting pivotal bending of the sections relative to each other upon installation of the seal element in a vehicle component.

The single track-like support member includes, along its length, a reduced thickness area, which forms a hinge structure, which permits pivoting of the member sections joined by the reduced thickness area relative to each other. This embodiment has the advantage that, for the manufacture of the seal element, a seal material can be molded onto, or otherwise applied to, the two edges of the track-like support member, while the support member is in a flattened state. Upon installation, the seal element can be bent about its hinge structure so that the two sections joined by the hinge structure form the angle as needed for the particular installation conditions.

The two sections of the support member at opposite sides of the hinge structure define walls for the reception space for the part to be sealed. The seal structures applied to the opposite sides of the support member can be so formed that, after bending of the support member about the hinge structure, the two seal structures are disposed in contact with each other so as to limit the reception space. The part to be sealed, for example a window of a vehicle when closed is received and sealingly engaged between the two seal structures.

In an expedient embodiment of the invention, the support member includes three sections that is a center section and two side sections with the seal bodies being molded onto the side sections. In such a three-section support member, the hinge area is provided between the center section and one of the two side sections. With such a three-section arrangement, the firmly connected side section may be arranged at a predetermined angle, for example at an angle of 90° with respect to the center section, so that the support member assumes a U-shape when the bendable side section is bent over at the hinge portion by 90° thereby forming a U-shaped reception space.

The support member preferably consists of a plastic material or of sheet metal for example of aluminum, which provides for a relatively high stability of the seal element. The embodiment in which the support member consists of metal further has the advantage that, upon bending about the hinge structure, a return moment remains because of the inherent elasticity of the support member, which, upon reception of the seal element in a recess in a vehicle component, is biased into firm engagement with the walls of the recess and, as a result, firmly retained in the recess.

A sealing lip may be molded onto the opposite side sections of each seal member between which the part to be sealed off is inserted.

Advantageous embodiments of the invention will be described below in greater detail on the basis of the accompanying drawing.

### BRIEF DESCRIPTION OF THE DRAWING

The sole figure shows a seal element with a support structure in an installation position in a vehicle component with seal structures molded onto opposite end sections of the support structure.

### DESCRIPTION OF A PREFERRED EMBODIMENT

The FIGURE shows a seal element 1 supported on a vehicle body part 2, for example, a window frame for the reception of a movable part such as a window panel 3. The seal element 1 has a reception space 6 into which the movable part, that is the window panel 3, extends in sealing relationship in the direction of the arrow.

For the transfer into the seal position, the window panel 3 is inserted in the direction of the arrow between two adjacent seal members 7 and 8, which are part of the seal element 1, into the reception space 6.

The seal element 1 comprises a track-like support structure 4, which has three sections, a center section 4a and two side sections 4b and 4c. Onto the side sections 4b and 4c, particularly onto the front sides of the side sections, seal structures 7 and 8 are molded, especially by injection molding, The seal structures 7, 9 consist expediently of an elastomer material. They include at the side remote from the side sections 4b and 4c of the support structure 4, seal lips 7a and respectively 8a, which abut each other when the window panel 3 is not inserted between the seal lips. With the window panel 3 inserted, the seal lips 7a and 8a abut the side walls of the window panel 3.

Between the center section 4a and the side section 4c of the support structure 4, there is an area 5, whose cross section is reduced when compared with the other areas of the support structure and which forms a hinge portion. The hinge portion permits pivoting of the adjacent section 4a and 4c about an axis extending in the longitudinal direction of the hinge structure as indicated by the arrow 9.

For the manufacturing, the support structure 4 is expediently arranged in a stretched position in which the center section 4a and the side section 4c are disposed in the same plane. Upon mounting and adapting to the installation position, the hinge portion 5, the two sections are pivoted relative to each other so as to be adapted to the installation position of the seal element structure.

In the embodiment shown in the figure, the seal element 1 is inserted in a recess 10 in the vehicle component 2 and the angle between the two sections 4a and 4c is adapted to the vehicle component 2 that is the walls forming the recess 6 as indicated by the arrow 9.

Since in the installation position of the side section 4c, which is separated from the center section 4a by the hinge portion 5, and also the opposite side section 4b extend at particular angles with respect to the center section 4a, for example at right angles, the support structure 4 is essentially U-shaped in cross-section.

What is claimed is:

1. A seal element for a movable vehicle component comprising: a support structure including at least two sections, seal structures disposed on said support structure, and a hinge portion disposed between, and joining, said two sections so as to permit pivotal bending of said two sections relative to each other about the hinge portion upon installation of the seal element in a vehicle component.

2. A seal element according to claim 1, wherein said support structure comprises a center section and opposite side sections of which at least one is joined to the center section by said hinge portion, and wherein said seal structures are seal members formed on said side sections by injection molding.

3. A seal element according to claim 2, wherein one of said side sections extends essentially normal to said center section and said hinge portion is disposed between said center section and the other side section.

4. A seal element according to claim 2, wherein, in the installation position of said seal element, a reception space is formed in said seal element.

5. A seal element according to claim 2, wherein each seal member has a seal lip (7a, 8a) molded thereon.

6. A seal element according to claim 1, wherein said seal members consist of an elastomer material.

7. A seal element according to claim 1, wherein said support structure consists of a plastic material.

8. A seal element according to claim 1, wherein said support structure consists of a sheet metal.
